(19) United States
(12) Patent Application Publication
(10) Pub. No.: US 2011/0047031 A1
(43) Pub. Date: Feb. 24, 2011

(54) Targeted Advertising Based on User-Created Profiles

(75) Inventor: Srilal Weerasinghe, Austin, TX (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T INTELLECTUAL PROPERTY I, LP., Reno, NV (US)

(21) Appl. No.: 12/544,394

(22) Filed: Aug. 20, 2009

(51) Int. Cl. G06Q 30/00

(52) U.S. Cl. 705/14.66

(57) ABSTRACT

Systems and methods for targeted advertising based on user-created profiles are disclosed. A particular method includes receiving a file at a web server during an Internet session, where the file is created by a user and includes profile information that is associated with the user and that is input into the file by the user. A targeted advertisement is selected for transmission from the web server to the user based on the profile information.

### FIELD OF THE DISCLOSURE

The present disclosure is generally related to targeted advertising.

### BACKGROUND

Internet advertising can be generally divided into two types: contextual advertising and targeted advertising. Most Internet advertising is contextual. That is, the advertisements displayed on a web page are related to the contents of the web page. For example, a health website may include advertisements for fitness clubs and a travel website may include advertisements for hotels. In contrast, targeted advertising may be tailored to an individual user's needs. A user's needs may be determined by tracking the user's behavior while the user browses the Internet. The tracked behavior may be used to develop a profile for the user, and targeted advertisements may be served to the user based on the profile. However, some users and privacy advocates frown on user behavior tracking.

Search engines commonly engage in user-tracking to generate revenue. For example, search engines may serve advertising related to a search query that a user has entered into the search engine. However, Internet service providers (ISPs) do not have the benefit of such visibility, even though the Internet traffic to and from the search engine flows through the ISP's network. User data collectable by ISPs is generally limited to website identifiers such as uniform resource locators (URLs) and Internet protocol (IP) addresses. To examine user content flowing through its networks, some ISPs engage in deep packet inspection (DPI) and serve targeted advertisements based on the results of the DPI. Such ISPs have dealt with negative publicity, consumer mistrust, and even congressional inquiry regarding the legality and ethics of DPI. ISPs that refuse to engage in DPI (e.g., for public relations reasons or other reasons) are currently at a disadvantage with respect to revenue generation from targeted advertising.

### BRIEF DESCRIPTION OF THE DRAWINGS

FIG. 1 is a block diagram of a particular embodiment of a system to deliver targeted advertising based on user-created profiles;

FIG. 2 is a diagram of a second embodiment of a system to deliver targeted advertising based on user-created profiles;

FIG. 3 is a flow diagram of a first embodiment of a method to deliver targeted advertising based on user-created profiles;

FIG. 4 is a flow diagram of a second embodiment of a method to deliver targeted advertising based on user-created profiles;

FIG. 5 is a screenshot of a particular embodiment of a targeted advertising profile creation template;

FIG. 6 is a screenshot of a particular embodiment of an Internet browser including functionality for targeted advertising based on user-created profiles; and

FIG. 7 is a block diagram of a particular embodiment of a general purpose computer system.

### DETAILED DESCRIPTION

Despite customer aversion to targeted advertising, an alternate methodology that does not depend on behavior tracking or deep packet inspection may find a more receptive advertising audience. Systems and methods for targeted advertising based on user-created profiles are disclosed. In a particular embodiment, a method includes receiving a file at a web server during an Internet session. The file is created by a user and includes profile information associated with the user that is input into the file by the user. The method also includes selecting a targeted advertisement for transmission from the web server to the user based on the profile information.

In another particular embodiment, a system includes a profile creation module to receive profile information from a user and to create a file that includes the profile information. The system also includes an Internet browsing module to receive a participation indication from the user and to selectively transmit a copy of the file to a web server based on the participation indication. The file is usable by the web server to select one or more targeted advertisements based on the profile information.

In another particular embodiment, a computer-readable storage medium includes instructions, that when executed by a processor, cause the processor to, at a server, receive a request for a web page from a computing device. The computer-readable storage medium also includes instructions, that when executed by the processor, cause the processor to receive an indication from the computing device that a user of the computing device desires to receive targeted advertising. The computer-readable storage medium further includes instructions, that when executed by the processor, cause the processor to retrieve a copy of a user-created file from the computing device. The user-created file includes profile information associated with the user that was input into the user-created file by the user. The computer-readable storage medium includes instructions, that when executed by the processor, cause the processor to select a targeted advertisement from a plurality of advertisements stored at a database, where the targeted advertisement is selected based on the profile information. The computer-readable storage medium also includes instructions, that when executed by the processor, cause the processor to retrieve the web page, insert the targeted advertisement into the web page, and transmit the web page including the targeted advertisement to the computing device.

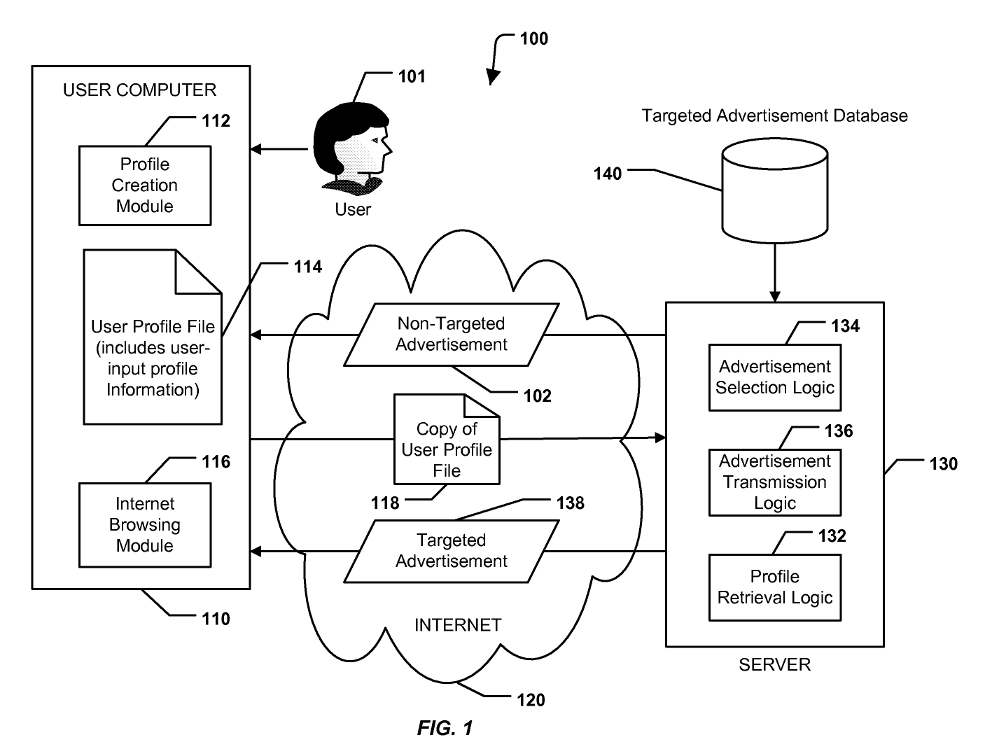

FIG. 1 depicts a particular embodiment of a system 100 to deliver targeted advertising based on user-created profiles. The system 100 includes a user computer 110 accessible by a user 101 and communicatively coupled to a server 130 via the Internet 120. Generally, the system 100 may enable the user computer 110 to transmit a user-created profile to the server 130 and may enable the server 130 to transmit targeted advertisements to the user computer 110 based on the user-created profile.

The user computer 110 includes a profile creation module 112 to receive profile information from the user 101 and to create a user profile file 114 that includes the profile information. In a particular embodiment, the user profile file 114 is a cookie file. The user profile file 114 may store the profile information in accordance with a user profile standard, such as a published standard (e.g., widely adopted key-value pairs) based on a request for comments (RFC) document. For example, the profile information may be stored at least partially in accordance with RFC2965 (“HTTP State Management Mechanism”), which introduced the “Cookie” HTTP header.

The profile information in the user profile file 114 may include age information, gender information, hobby information (e.g., favorite hobbies of the user 101), income information, location information (e.g., a geographic location of the user 101), or other information relevant to the user 101. The profile information in the user profile file 114 may also include one or more keywords input by the user 101, where each keyword indicates that the user desires targeted advertising associated with the keyword. For example, the user 101 may be planning an upcoming vacation and may include keywords such as “vacation,” “cheap,” “airfare,” “destination,” and “beach” in the profile information. The profile information in the user profile file 114 may also include a link (e.g., a uniform resource locator (URL)) to a social networking profile. Thus, if the user 101 has already taken the time to create a detailed online social networking profile, the user 101 need not duplicate the profile creation effort in order to receive properly targeted advertisements. Instead, the social networking profile may be used in selecting targeted advertisements as described herein.

In a particular embodiment, the profile creation module 112 is a web browser extension that may be downloaded by and installed to the user computer 110. Alternately, the profile creation module 112 may be a software plug-in or a toolbar. The profile creation module 112 may also include a voice recognition interface to aid the user 101 in creating the user profile file 114.

The user computer 110 also includes an Internet browsing module 116. The Internet browsing module 116 receives a participation indication from the user 101 that indicates whether or not the user 101 desires targeted advertising based on the profile information in the user profile file 114. The Internet browsing module 116 selectively transmits a copy of the user profile file 118 to the server 130 based on the participation indication. In a particular embodiment, the Internet browsing module 116 transmits the participation indication to the server 130, and the server 130 requests a copy of the user profile file 118 from the Internet browsing module 116 in response to receiving the participation indication. In another particular embodiment, the Internet browsing module 116 transmits a copy of the user profile file 118 to the server 130 without waiting for the server 130 to request the copy of the user profile file 118. For example, the user 101 may select an option (e.g., a check-box, a radio button, or other control) in the Internet browsing module 116 indicating that the user 101 desires targeted advertising. In response, the Internet browsing module 116 may transmit the copy of the user profile file 118 to the server 130 so that the server 130 may select and present targeted advertisements to the user 101 based on the profile information contained in the copy of the user profile file 118. In a particular embodiment, the Internet browsing module 116 includes a web browser. In another particular embodiment, the Internet browsing module 116 automatically adds Internet search terms to the profile information in the user profile file 114. In yet another particular embodiment, the Internet browsing module 116 enables the user 101 to create blacklists that include websites to not send the copy of the user profile file 118 to, whitelists that include websites to automatically send the copy of the user profile file 118 to, or any combination thereof.

The server 130 may include profile retrieval logic 132, advertisement selection logic 134, and advertisement transmission logic 136. The profile retrieval logic 132 may extract profile information associated with the user 101 from the copy of the user profile file 118. The profile retrieval logic 132 may also retrieve extended profile information based on the profile information in the copy of the user profile file 118. For example, when the profile information includes a link to a social networking profile, the profile analysis 132 may navigate to the social networking profile based on the link and retrieve extended profile information from the social networking profile.

The advertisement selection logic 134 may select one or more targeted advertisements to present to the user 101 based on the profile information (and extended profile information, if any) retrieved by the profile retrieval logic 132. In a particular embodiment, the advertisement selection logic 134 is configured to select the one or more targeted advertisements from a targeted advertisement database 140 maintained by and coupled to the server 130. For example, the server 130 may be an ISP web server, and the targeted advertisement database 140 may include targeted advertising associated with advertisers that have an arrangement with the ISP. For example, the database 140 may include advertisements associated with advertisers that have cost per impression (CPM) contracts with the ISP, cost per click (CPC) contracts with the ISP, cost per acquisition (CPA) contracts with the ISP, cost per lead (CPL) contracts with the ISP, or any combination thereof.

The advertisement transmission logic 136 may transmit a targeted advertisement 138 (e.g., a banner advertisement, a skyscraper advertisement, a pop-up advertisement, a pop-under advertisement, an interstitial advertisement, an audio clip advertisement, a video clip advertisement, a text-based advertisement, some other type of advertisement, or any combination thereof) selected by the advertisement selection logic 136 to the user computer 110. In a particular embodiment, when the user 101 does not desire to receive targeted advertisements based on the profile information in the user profile file 114 (e.g., the user 101 instructs the Internet browsing module 116 to not send the copy of the user profile file 118 to the server 130), the advertisement transmission logic 136 may transmit the non-targeted advertisement 102 to the user computer 110. For example, the non-targeted advertisement 102 may be a randomly selected advertisement from the database 140.

In operation, the user 101 may operate the user computer 110 to browse the Internet 120. Occasionally, the server 130 (e.g., an ISP web server through which Internet traffic associated with the user passes) may transmit non-targeted advertisements (e.g., the non-targeted advertisement 102) to the user computer 110. While browsing, the user 101 may decide that he or she wishes to receive targeted advertising. For example, the user 101 may desire targeted advertising regarding an upcoming vacation. The user 101 may create (or update) the user profile file 114 using the profile creation module 112 and instruct the Internet browsing module 116 to transmit the copy of the user profile file 118 to the server 130.

Upon receiving the copy of the user profile file 118, the profile retrieval logic 132 at the server 130 may extract profile information from the copy of the user profile file 118, and the advertisement selection logic 134 may select a targeted advertisement from the database 140 based on the extracted profile information. For example, the profile information may include the keywords “vacation,” “cheap,” “airfare,” “destination,” and “beach,” and a link to a social networking profile where the user 101 has entered “I've always wanted to visit Hawaii” in an “Interests” section of the social networking profile. Based on the extracted and retrieved profile information, the advertisement selection logic 134 may select an advertisement for a discount flight and beachfront hotel package in Honolulu, and the advertisement transmission logic 136 may transmit the selected targeted advertisement 138 to the user computer 110, where the Internet browsing module 116 displays the selected targeted advertisement 138 to the user 101. In a particular embodiment, the advertisement transmission logic 136 transmits the selected targeted advertisement 138 by inserting the selected targeted advertisement 138 into a web page that the user has requested while browsing the Internet and then transmitting the web page with the inserted targeted advertisement 138 to the user computer 110.

It will be appreciated that the system 100 of FIG. 1 effectively reverses the advertising cookie paradigm. In typical advertising implementations, a server creates a file (e.g., a cookie file) at a user computer that stores behavioral tracking information associated with the user. In contrast, the system 100 of FIG. 1 enables the user 101 to control if and when the user profile file 114 is created, enables the user 101 to enter and delete profile information to and from the file 114, and enables the user 101 to “turn on” and “turn off” participation in targeted advertising with respect to individual websites. Thus, because the user 101 is in control of the advertising process, targeted advertising selected and served to the user 101 in accordance with the system 100 of FIG. 1 may find a receptive audience. In addition, when the user profile file 114 is a cookie, the system 100 of FIG. 1 may be implemented without needing to make substantial changes to existing server frameworks that already include cookie retrieval and cookie analysis functionality. In a particular embodiment, the user profile file 114 and information therein is modifiable (e.g., updateable and deleteable) by the user 101, but not the server 130, and the server 130 is configured to delete the copy of the user profile file 118 (e.g., once a targeted advertisement is selected, once a targeted advertisement is transmitted, or after a predetermined profile expiration time period), further enhancing user control of the targeted advertising process.

It will also be appreciated that by keeping a copy of profile information at the user computer, the system 100 of FIG. 1 may enable the same profile information to be used by the server 130 in selecting targeted advertising for insertion into web pages of different websites and during multiple Internet sessions. For example, when the user 101 elects to participate in targeted advertising, targeted advertisements regarding discount vacation packages may be presented to the user regardless of what website the user 101 is actually browsing. It will further be appreciated that the system 100 of FIG. 1 may enable ISPs to serve targeted advertisements to users without engaging in deep packet inspection and without analyzing Internet browsing history of the ISP's users.

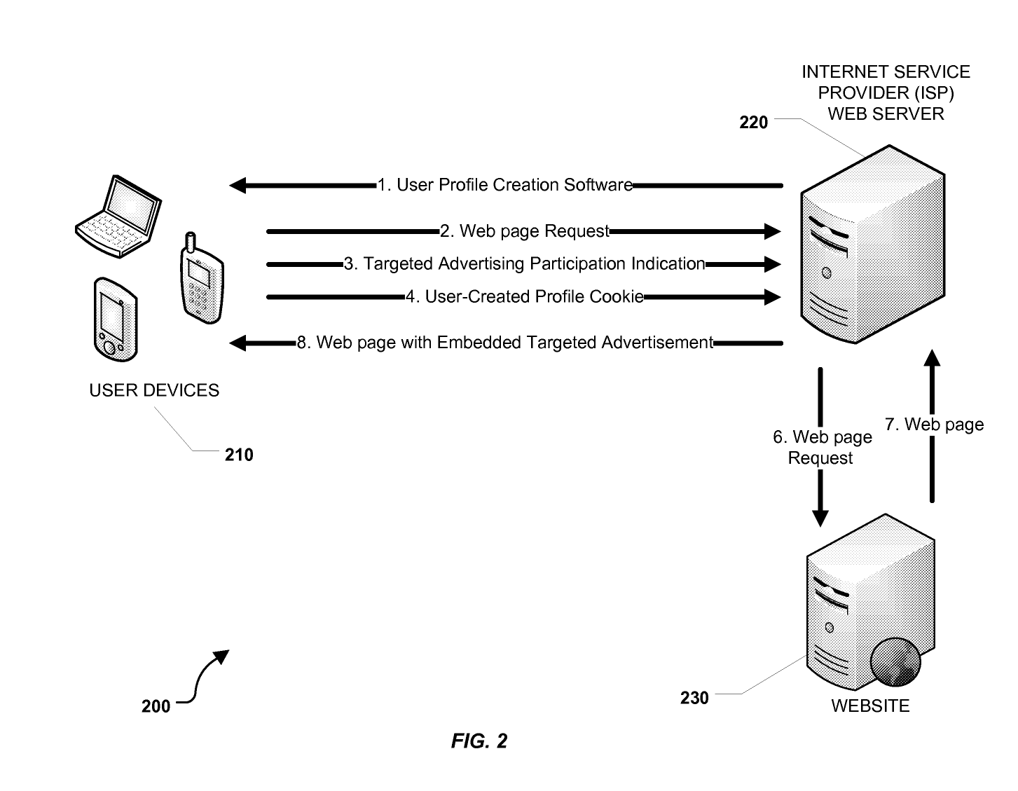

FIG. 2 depicts another particular embodiment of a system 200 to deliver targeted advertising based on user-created profiles. The system 200 includes one or more user devices 210 that are each configured to browse the Internet (e.g., visit the website 230) via an ISP web server 220.

The user devices 210 may include devices that have Internet browsing capability. For example, the user devices 210 may include computing devices such as desktop computers, laptop computers, netbook computers, or other computing devices. The user devices 210 may also include mobile devices such as cellular phones, smartphones, and other mobile devices. Each of the user devices 210 may be configured to send and receive information from the ISP web server 220. In an illustrative embodiment, the user devices 210 include the user computer 110 of FIG. 1.

The ISP web server 220 may act as an Internet gateway for the user devices 210. For example, the ISP web server 220 may receive a request for a web page of the website 230 from the user devices 210, retrieve the web page from the website 230, and transmit the web page to the user devices 210. In an illustrative embodiment, the ISP web server 220 includes the web server 130 of FIG. 1 and is configured to insert targeted advertisements into the web page of the website 230 before transmitting the web page to the user devices 210. In a particular embodiment, the ISP web server 220 is also configured to detect that the user devices 210 do not have user profile creation software (e.g., the profile creation module 112 of FIG. 1) and transmit the user profile creation software to the user devices 210.

In operation, one of the user devices 210 may browse the Internet via the ISP web server 220. The ISP web server 220 may detect that the user device (e.g., one of the user devices 210) does not have user profile creation software installed and may offer to send user profile creation software (e.g., a downloadable software installation package) to the user device. The user device may receive the user profile creation software, and a user operating the user device may employ the software to create a user profile cookie for use in targeted advertising.

The user device may then transmit a web page request for a web page of the website 230 to the ISP web server 220. The user device may also transmit a targeted advertising participation indication to the ISP web server 220. When the targeted advertising participation indication indicates that the user does not desire targeted advertising, the ISP web server 220 may request the web page from the website 230, receive the web page from the website 230, and transmit the web page to the user device as-is or with non-targeted advertisements inserted into the web page.

When the targeted advertising participation indication indicates that the user desires targeted advertising, the user device may also transmit a copy of the user-created profile cookie to the ISP web server 220. The ISP web server 220 may use the user-created profile cookie to select one or more targeted advertisements to insert into the web page of the website 230 before transmitting the web page to the user device.

It will be appreciated the system 200 of FIG. 2 may enable ISPs to provide user profile creation software to the user devices 210, so that users of the user devices 210 may create cookie files and participate in targeted advertising. For example, ISPs may incentivize participation in targeted advertising by offering discounted Internet service to users that create profiles and participate in targeted advertising as described herein.

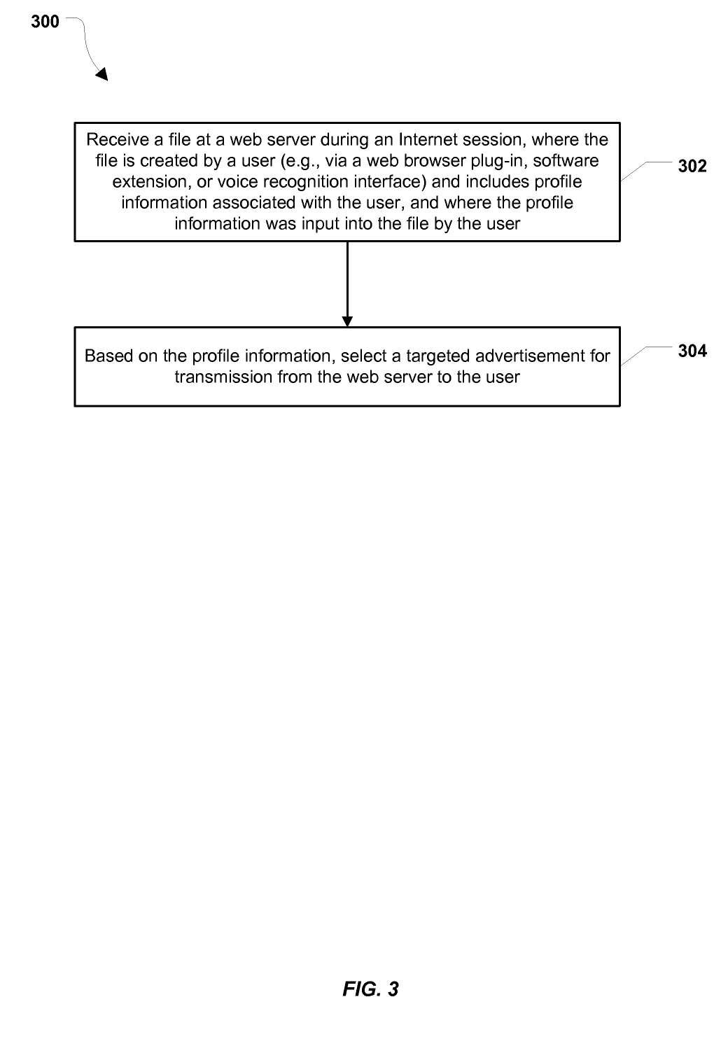

FIG. 3 depicts a particular embodiment of a method 300 of targeted advertising based on user-created profiles. In an illustrative embodiment, the method 300 may be performed by the server 130 of FIG. 1 or the ISP web server 220 of FIG. 2.

The method 300 includes receiving a file at a web server during an Internet session, at 302. The file is created by a user (e.g., via a web browser plug-in, software extension, or voice recognition interface) and includes profile information that is associated with the user and input into the file by the user. For example, in FIG. 1, the server 130 may receive the copy of the user profile file 118. The copy of the user profile file 118 is a copy of the user profile file 114 that was created by the user 101 and includes profile information associated with the user 101 that was input into the file 114 by the user 101.

The method 300 also includes, based on the profile information, selecting a targeted advertisement for transmission from the web server to the user. For example, in FIG. 1, the advertisement selection logic 134 may select the targeted advertisement 138 for transmission from the server 130 to the user computer 110 of the user 101, where the targeted advertisement 138 is selected based on the profile information in the copy of the user profile file 118.

It will be appreciated that servers (e.g., ISP web servers) implementing the method 300 of FIG. 3 may serve targeted advertisements to users based on voluntarily created user profiles.

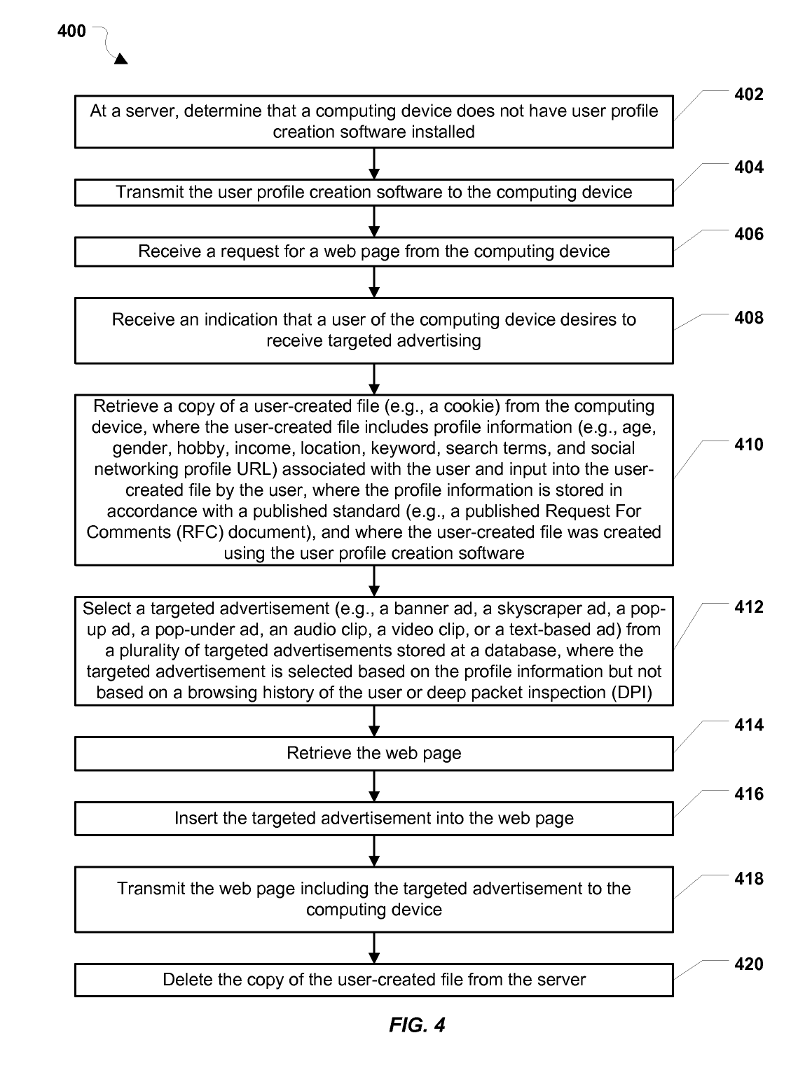

FIG. 4 depicts another particular embodiment of a method 400 of targeted advertising based on user-created profiles. In an illustrative embodiment, the method 400 may be performed by the server 130 of FIG. 1 or the ISP web server 220 of FIG. 2.

The method 400 includes, at a server, determining that a computing device does not have user profile creation software installed, at 402. For example, in FIG. 1, the server 130 may determine that the user computer 110 does not have the profile creation module 112 installed. The method 400 also includes transmitting the user profile creation software to the computer, at 404. For example, in FIG. 1, the server 130 may transmit the profile creation module 112 to the user computer 110. In an illustrative embodiment, the transmission occurs as described herein with respect to the user profile creation software transmitted by the ISP web server 220 of FIG. 2 to the user devices 210 of FIG. 2.

The method 400 further includes receiving a request for a web page from the computing device, at 406. For example, in FIG. 1, the server 130 may receive a request for a web page from the Internet browsing module 116. The method 400 includes receiving an indication that a user of the computing device desires to receive targeted advertising, at 408. For example, in FIG. 1, the server 130 may receive an indication from the user computer 110 that the user 101 desires targeted advertising.

The method 400 also includes retrieving a copy of a user-created file (e.g., a cookie file) from the computing device, at 410. The user-created file includes profile information (e.g., age, gender, hobby, income, location, keyword, search terms, and social networking profile URL) associated with the user and input into the user-created file by the user. The profile information may be stored in accordance with a published standard such as a request for comments (RFC) document (e.g., a key-value pair standard agreed upon by ISPs wishing to implement targeted advertising based on user-created profiles as described herein). The user-created profile may have been created using the profile creation software. For example, in FIG. 1, the server 130 may receive the copy of the user profile file 118.

The method 400 further includes selecting a targeted advertisement (e.g., a banner advertisement, a skyscraper advertisement, a pop-up advertisement, a pop-under advertisement, an audio clip, a video clip, or a text-based advertisement) from a plurality of targeted advertisements stored at a database, at 412. The targeted advertisement is selected based on the profile information but not based on a browsing history of the user or deep packet inspection DPI. For example, referring to FIG. 1, the targeted advertisement 138 may be selected based on the profile information but not based on a browsing history of the user 101 and not based on DPI.

The method 400 includes retrieving the web page, at 414. For example, referring to FIG. 1, the server 130 may retrieve the web page. In an illustrative embodiment, the web page is retrieved as described herein with respect to the ISP web server 220 of FIG. 2 retrieving a web page of the website 230 of FIG. 2.

The method 400 also includes inserting the targeted advertisement into the web page, at 416, and transmitting the web page including the targeted advertisement to the computing device, at 418. For example, referring to FIG. 1, the server 130 may insert the targeted advertisement 138 into the web page and transmit the web page including the targeted advertisement 138 to the user computer 110.

The method 400 includes deleting the copy of the user-created file from the server, at 418. For example, referring to FIG. 1, the server 130 may delete the copy of the user profile file 118.

It will be appreciated that servers (e.g., ISP web servers) implementing the method 400 of FIG. 4 may generate revenue by inserting targeted advertising based on user-created profiles into web pages requested by users.

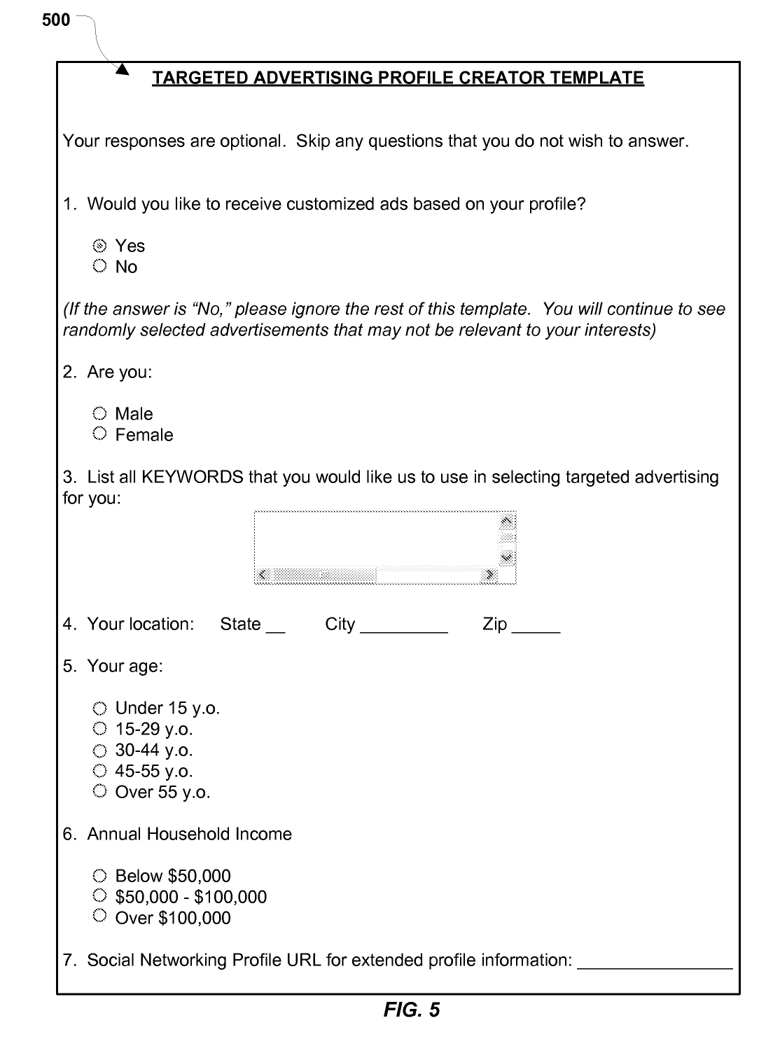

FIG. 5 depicts a screenshot of a particular embodiment of a targeted advertising profile creation template 500. In an illustrative embodiment, the template 500 may be utilized by the profile creation module 112 of FIG. 1 to enable the user 101 of FIG. 1 to create the user profile file 114 of FIG. 1.

In the particular embodiment illustrated in FIG. 5, the template 500 is a questionnaire. However, it should be noted that the template 500 may instead be any other form that a user may use in providing information to be used to select targeted advertisements.

When the template 500 is a questionnaire, the template 500 may include one or more questions regarding gender, location, age, and income as illustrated in FIG. 5. The template 500 may also include a way (e.g., a text box) for users to enter keywords regarding which the user desires targeted advertising. The template 500 may also include a way for users to enter links to social networking profiles that may be data-mined for extended profile information to be used in selecting targeted advertisements.

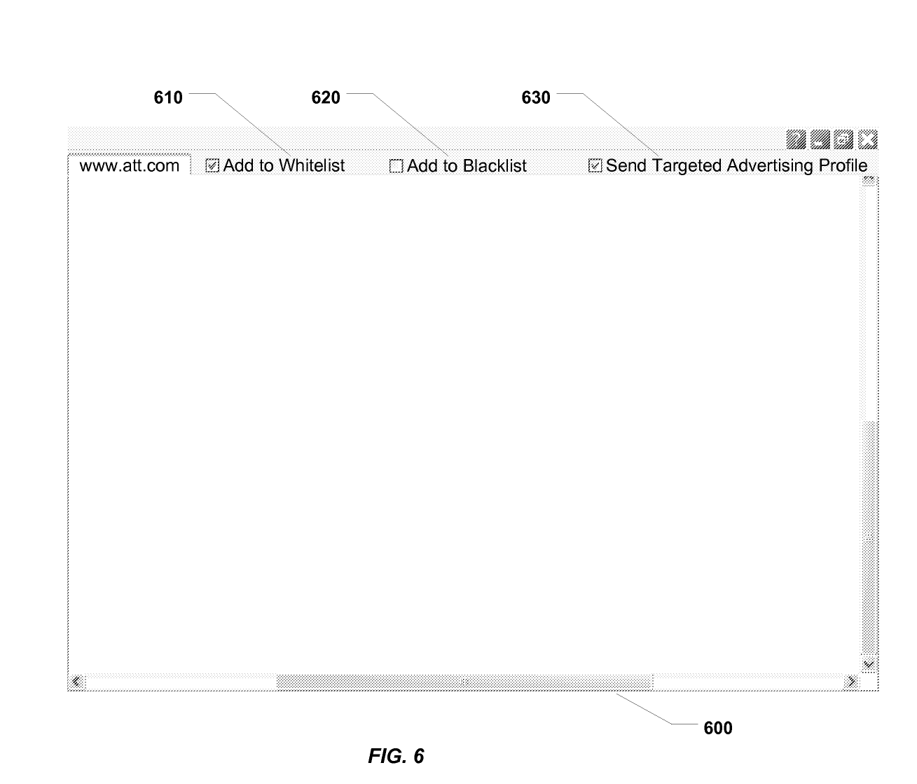

FIG. 6 is a screenshot of a particular embodiment of an Internet browser 600 including functionality for targeted advertising based on user-created profiles. In an illustrative embodiment, the browser 600 includes the Internet browsing module 116 of FIG. 1.

The browser 600 may include a method to add websites to a targeted advertising whitelist, a method to add websites to a targeted advertising blacklist, and a method to selectively participate in targeted advertising on a website-by-website basis. For example, in the particular embodiment illustrated in FIG. 6, the browser 600 includes a checkbox 610 to add a currently-visited website (e.g., www.att.com) to a whitelist, a checkbox 620 to add the currently-visited website to a blacklist, and a checkbox 630 to selectively send a targeted advertising profile (e.g., a user-created profile cookie) for use in selecting targeted advertisements for insertion into only the currently visited website. It should be noted that although the browser 600 as illustrated in FIG. 6 employs checkboxes, the browser 600 may instead employ any other graphical user interface (GUI) controls.

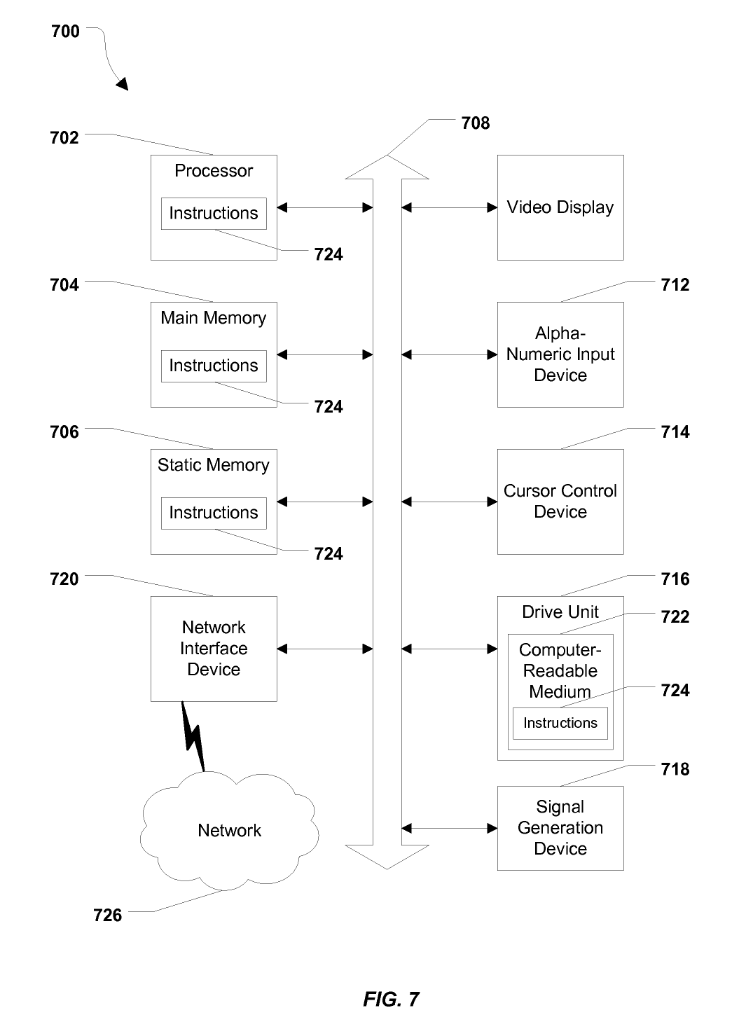

Referring to FIG. 7, an illustrative embodiment of a general computer system is shown and is designated 700. The computer system 700 can include a set of instructions that can be executed to cause the computer system 700 to perform any one or more of the methods or computer based functions disclosed herein. The computer system 700 may operate as a standalone device or may be connected, e.g., using a network, to other computer systems or peripheral devices. For example, the computer system 700 may include or be included within any one or more of the user computer 110, the server 130, the database 140, the user devices 210, the ISP web server 220, and the website 230 discussed with reference to FIGS. 1-6.

In a networked deployment, the computer system may operate in the capacity of a server or as a client user computer in a server-client user network environment, or as a peer computer system in a peer-to-peer (or distributed) network environment. The computer system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a pager, a personal trusted device, a web appliance, or any other machine capable of executing a set of instructions (sequential or otherwise) that specify actions to be taken by that machine. In a particular embodiment, the computer system 700 can be implemented using electronic devices that provide voice, video, or data communication. Further, while a single computer system 700 is illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, e.g., a central processing unit (CPU), a graphics processing unit (GPU), or both. Moreover, the computer system 700 can include a main memory 604 and a static memory 706 that can communicate with each other via a bus 708. As shown, the computer system 700 may further include a video display unit 710, such as a liquid crystal display (LCD), an organic light emitting diode (OLED), a flat panel display, or a solid state display. Additionally, the computer system 700 may include an input device 712, such as a keyboard, and a cursor control device 714, such as a mouse. The computer system 700 can also include a disk drive unit 716, a signal generation device 718, such as a speaker or remote control, and a network interface device 720.

In a particular embodiment, as depicted in FIG. 7, the disk drive unit 716 may include a computer-readable medium 722 in which one or more sets of instructions 724, e.g. software, can be embedded. Further, the instructions 724 may embody one or more of the methods or logic as described herein. In a particular embodiment, the instructions 724 may reside completely, or at least partially, within the main memory 704, the static memory 706, and/or within the processor 702 during execution by the computer system 700. The main memory 704 and the processor 702 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 724 or receives and executes instructions 724, so that a device connected to a network 726 can communicate voice, video or data over the network 726. Further, the instructions 724 may be transmitted or received over the network 726 via the network interface device 720 or residential gateway 730 connected to the network interface device 720.

While the computer-readable medium 722 is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device. Accordingly, the disclosure is considered to include any one or more of a computer-readable medium and other equivalents and successor media, in which data or instructions may be stored.

Although the present specification describes components and functions that may be implemented in particular embodiments with reference to particular standards and protocols, the disclosed embodiments are not limited to such standards and protocols. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method, comprising:
receiving a file at a web server during an Internet session, wherein the file is created by a user, wherein the file includes profile information associated with the user, and wherein the profile information is input into the file by the user; and
based on the profile information, selecting a targeted advertisement for transmission from the web server to the user.

2. The method of claim 1, further comprising before receiving the file at the web server:
receiving an indication from the user that the file exists; and
sending a request for the file to a computer of the user, wherein a copy of the file is sent to the server and wherein the file remains at the computer for use during subsequent Internet sessions.

3. The method of claim 1, further comprising inserting the targeted advertisement into a web page requested by the user and transmitting the web page including the targeted advertisement to the user.

4. The method of claim 1, wherein the file is usable by the web server to select targeted advertisements for insertion into other web pages.

5. The method of claim 1, further comprising deleting the file from the web server after selecting the targeted advertisement.

6. The method of claim 1, wherein the file is a cookie file.

7. The method of claim 1, wherein the profile information includes age information, gender information, hobby information, income information, location information, at least one keyword that indicates that the user desires targeted advertising associated with the at least one keyword, or any combination thereof.

8. The method of claim 1, wherein targeted advertisement is not selected based on an Internet browsing history of the user or based on deep packet inspection (DPI).

9. The method of claim 1, wherein the profile information includes at least one link to a social networking profile and further comprising retrieving extended profile information from the social networking profile, wherein the targeted advertisement is further selected based on the extended profile information.

10. The method of claim 1, wherein the web server transmits non-targeted advertisements to the user when the user elects not to send the copy of the file to the web server.

11. The method of claim 1, wherein the targeted advertisement is a banner advertisement, a skyscraper advertisement, a pop-up advertisement, a pop-under advertisement, an interstitial advertisement, an audio clip advertisement, a video clip advertisement, a text-based advertisement, or any combination thereof.

12. A system, comprising:
a profile creation module to receive profile information from a user and to create a file that includes the profile information; and
an Internet browsing module to receive a participation indication from the user and to selectively transmit a copy of the file to a web server based on the participation indication,
wherein the file is usable by the web server to select one or more targeted advertisements based on the profile information.

13. The system of claim 12, wherein the profile creation module includes a web browser extension, a software plug-in, a toolbar, a voice recognition interface, or any combination thereof.

14. The system of claim 12, wherein the file stores the profile information in accordance with a user profile standard.

15. The system of claim 14, wherein the user profile standard is based on a published request for comments (RFC) document.

16. The system of claim 12, wherein at least one of the profile creation module and the Internet browsing module is located at a mobile device.

17. The system of claim 12, wherein the profile information stored in the file can be updated and deleted by the user, but is not modifiable by the web server.

18. The system of claim 12, wherein the Internet browsing module automatically adds Internet search terms to the profile information in the file and wherein the Internet browsing module enables the user to create a blacklist comprising websites to not send the file to, a whitelist comprising websites to send the file to, or any combination thereof.

19. A computer-readable medium storage comprising instructions, that when executed by a processor, cause the processor to:
at a server, receive a request for a web page from a computing device;
receive an indication from the computing device that a user of the computing device desires to receive targeted advertising;
retrieve a copy of a user-created file from the computing device, wherein the user-created file includes profile information associated with the user and wherein the profile information was input into the user-created file by the user;
select a targeted advertisement from a plurality of advertisements stored at a database, wherein the targeted advertisement is selected based on the profile information;
retrieve the web page;
insert the targeted advertisement into the web page; and
transmit the web page including the targeted advertisement to the computing device.

20. The computer-readable storage medium of claim 19, further comprising instructions, that when executed by the processor, cause the processor to:
determine that the computing device does not have user profile creation software installed; and
transmit the user profile creation software to the computing device, wherein the user profile creation software enables the user to create the user-created file.
